(19) United States
(12) Patent Application Publication
(10) Pub. No.: US 2014/0201167 A1
(43) Pub. Date: Jul. 17, 2014

(54) SYSTEMS AND METHODS FOR FILE SYSTEM MANAGEMENT

(71) Applicant: DELL PRODUCTS L.P., Round Rock, TX (US)

(72) Inventors: Itay Dar, Rishon LeZion (IL); Guy Margalit, Tel-Aviv (IL)

(73) Assignee: DELL PRODUCTS L.P., Round Rock, TX (US)

(21) Appl. No.: 13/743,876

(22) Filed: Jan. 17, 2013

(51) Int. Cl. G06F 17/30

(52) U.S. Cl. CPC G06F 17/30117
USPC 707/692

(57) ABSTRACT

A method may include in response to receiving a command to delete data on a storage resource, determining, whether a storage unit has an area to delete responsive to the command that is not aligned with boundaries of the storage unit. The method may also include in response to determining that the storage unit has an area to delete responsive to the command that is unaligned with boundaries of the storage unit, determining whether the entire storage unit, other than the area to delete responsive to the command that is unaligned with boundaries of the storage unit, is marked for unmapping. The method may further include in response to determining that the entire storage unit, other than the area to delete responsive to the command that is unaligned with boundaries of the storage unit, is marked for unmapping, unmapping the storage unit from a logical-to-physical map for the storage resource.

### TECHNICAL FIELD

The present disclosure relates in general to information handling systems, and more particularly to file system management.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

An information handling system typically stores data on one or more storage resources in logically addressable files which are then stored in binary form on the storage resource. The manner in which data is stored on a storage resource is typically governed by a file system for the storage resource that defines how data may be logically and physically addressed on a storage resource. A typical traditional file system manages data using files in which each file is associated with a mapping structure (e.g., a B tree or a radix tree) which maps logical storage addresses into physical storage addresses on the storage resource. Using such mapping structure, the file system may serve reads to non-cached data and allow for update of file data in the case of an operation overwriting stored data. At some point in time, a file may be deleted and the storage space associated with it may be unmapped, thus returning the free space to the file system so that it may be reused.

In many implementations, logical-to-physical mappings must have a minimal size which align to a particular unit of storage (e.g., a block or a page). In many cases it may be desirable to support deletion within a specific range of storage not aligned to a particular unit of storage. However, existing file systems are often limited to deletions which are aligned to mapping block offsets with a tree or that might cause a mapping structure to become congested with many small entries due to a mapping structure becoming fragmented.

### SUMMARY

In accordance with the teachings of the present disclosure, the disadvantages and problems associated with traditional approaches to file system management have been reduced or eliminated.

In accordance with embodiments of the present disclosure, a method may include in response to receiving a command to delete data on a storage resource, determining, for a storage unit of the storage resource comprising a range of data to be deleted in response to the command, whether such storage unit has an area to delete responsive to the command that is not aligned with boundaries of the storage unit. The method may also include in response to determining that the storage unit has an area to delete responsive to the command that is not aligned with boundaries of the storage unit, determining whether the entire storage unit, other than the area to delete responsive to the command that is not aligned with boundaries of the storage unit, is marked for unmapping. The method may further include in response to determining that the entire storage unit, other than the area to delete responsive to the command that is not aligned with boundaries of the storage unit, is marked for unmapping, unmapping the storage unit from a logical-to-physical map for the storage resource. The method may additionally include in response to determining that a portion of the storage unit, other than the area to delete responsive to the command that is not aligned with boundaries of the storage unit, is not marked for unmapping, modifying the storage unit to mark the area to delete responsive to the command that is not aligned with boundaries of the storage unit for unmapping.

In accordance with these and other embodiments of the present disclosure, an information handling system may include a storage resource and a processor communicatively coupled to the storage resource. The processor may be configured to: (i) in response to receiving a command to delete data on the storage resource, determine, for a storage unit of the storage resource comprising a range of data to be deleted in response to the command, whether such storage unit has an area to delete responsive to the command that is not aligned with boundaries of the storage unit; (ii) in response to determining that the storage unit has an area to delete responsive to the command that is not aligned with boundaries of the storage unit, determine whether the entire storage unit, other than the area to delete responsive to the command that is not aligned with boundaries of the storage unit, is marked for unmapping; (iii) in response to determining that the entire storage unit, other than the area to delete responsive to the command that is not aligned with boundaries of the storage unit, is marked for unmapping, unmap the storage unit from a logical-to-physical map for the storage resource; and (iv) in response to determining that a portion of the storage unit, other than the area to delete responsive to the command that is not aligned with boundaries of the storage unit, is not marked for unmapping, modify the storage unit to mark the area to delete responsive to the command that is not aligned with boundaries of the storage unit for unmapping.

In accordance with these and other embodiments of the present disclosure, an article of manufacture may include a computer readable medium and computer-executable instructions carried on the computer readable medium, the instructions readable by a processor. The instructions may be configured to, when read and executed, for cause the processor to: (i) in response to receiving a command to delete data on the storage resource, determine, for a storage unit of the storage resource comprising a range of data to be deleted in response to the command, whether such storage unit has an area to delete responsive to the command that is not aligned with boundaries of the storage unit; (ii) in response to determining that the storage unit has an area to delete responsive to the command that is not aligned with boundaries of the storage unit, determine whether the entire storage unit, other than the area to delete responsive to the command that is not aligned with boundaries of the storage unit, is marked for unmapping; (iii) in response to determining that the entire storage unit, other than the area to delete responsive to the command that is not aligned with boundaries of the storage unit, is marked for unmapping, unmap the storage unit from a logical-to-physical map for the storage resource; and (iv) in response to determining that a portion of the storage unit, other than the area to delete responsive to the command that is not aligned with boundaries of the storage unit, is not marked for unmapping, modify the storage unit to mark the area to delete responsive to the command that is not aligned with boundaries of the storage unit for unmapping.

Technical advantages will be apparent to those of ordinary skill in the art in view of the following specification, claims, and drawings.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with certain embodiments of the present disclosure;

FIG. 2 illustrates a flow chart of an example method for managing deletion of data on a storage resource, in accordance with the present disclosure; and

FIG. 3 illustrates a flow diagram relating to an area of storage on a storage resource to further illustrate the operation of the method depicted in FIG. 2, in accordance with the present disclosure.

### DETAILED DESCRIPTION

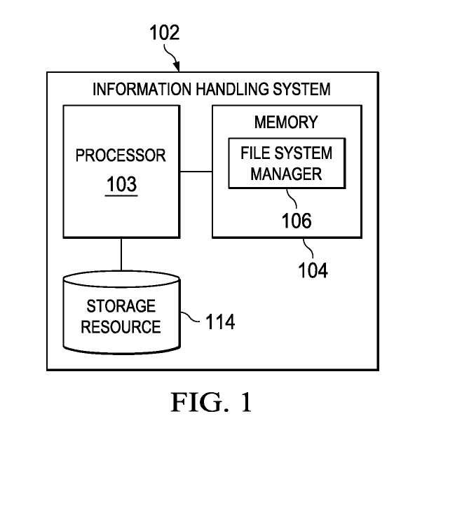

Preferred embodiments and their advantages are best understood by reference to FIGS. 1-3, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more busses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems (BIOSs), busses, memories, I/O devices and/or interfaces, storage resources, network interfaces, motherboards, and/or any other components and/or elements of an information handling system.

An information handling system may include or may be coupled to an array of physical storage resources. The array of physical storage resources may include a plurality of physical storage resources, and may be operable to perform one or more input and/or output storage operations, and/or may be structured to provide redundancy. In operation, one or more physical storage resources disposed in an array of physical storage resources may appear to an operating system as a single logical storage unit or “virtual storage resource.”

In certain embodiments, an array of physical storage resources may be implemented as a Redundant Array of Independent Disks (also referred to as a Redundant Array of Inexpensive Disks or a RAID). RAID implementations may employ a number of techniques to provide for redundancy, including striping, mirroring, and/or parity generation/checking. As known in the art, RAIDs may be implemented according to numerous RAID levels, including without limitation, standard RAID levels (e.g., RAID 0, RAID 1, RAID 3, RAID 4, RAID 5, and RAID 6), nested RAID levels (e.g., RAID 01, RAID 03, RAID 10, RAID 30, RAID 50, RAID 51, RAID 53, RAID 60, RAID 100), non-standard RAID levels, or others.

FIG. 1 illustrates a block diagram of an example information handling system 102, in accordance with certain embodiments of the present disclosure. In certain embodiments, information handling system 102 may be a server. In another embodiment, information handling system 102 may be a dedicated storage system such as, for example, a network attached storage (NAS) system or an external block storage controller responsible for operating on the data in a storage resource 114 and sending and receiving data from hosts coupled to the storage system. As depicted in FIG. 1, an information handling system 102 may include a processor 103, a memory 104 communicatively coupled to processor 103, and a storage resource 114 communicatively coupled to processor 103.

Processor 103 may include any system, device, or apparatus configured to interpret and/or execute program instructions and/or process data, and may include, without limitation a microprocessor, microcontroller, digital signal processor (DSP), application specific integrated circuit (ASIC), or any other digital or analog circuitry configured to interpret and/or execute program instructions and/or process data. In some embodiments, a processor 103 may interpret and/or execute program instructions and/or process data stored in memory 104, stored on storage resource 114, and/or another component of an information handling system 102.

Memory 104 may be communicatively coupled to an associated processor 103 and may include any system, device, or apparatus configured to retain program instructions and/or data for a period of time (e.g., computer-readable media). A memory 104 may include RAM, EEPROM, a PCMCIA card, flash memory, magnetic storage, opto-magnetic storage, or any suitable selection and/or array of volatile or non-volatile memory that retains data after power to an information handling system 102 is turned off.

As shown in FIG. 1, memory 104 may have stored thereon file system manager 106. File system manager 106 may include any system, device, or apparatus configured to manage a file system present on storage resource 114, including maintaining relevant mappings between logical and physical addressing schemes of storage resource 114. In some embodiments, file system manager 106 may be implemented as a program of instructions that may be read by and executed on processor 103 to carry out the functionality of file system manager 106. In some embodiments, file system manager 106 may be configured to perform method 200, described below.

Storage resource 114 may include one or more hard disk drives, magnetic tape libraries, optical disk drives, magneto-optical disk drives, compact disk drives, compact disk arrays, disk array controllers, and/or any computer-readable medium operable to store data. In some embodiments, storage resource 114 may form all or part of a redundant storage array (e.g., a RAID). In such embodiments, computer-readable media participating in the redundant storage array may appear to an operating system executing on information handling system 102 as a single logical storage unit or virtual resource. Thus, information handling system 102 may “see” a logical unit instead of seeing each individual physical storage resource 114. Although FIG. 1 depicts storage resource 114 as integral to information handling system 102, in some embodiments, one or more storage resources 114 may be externally coupled to information handling system 102 (e.g., via a network, a locally wired connection, etc.).

In addition to processor 103, memory 104, and storage resource 114, information handling system 102 may include one or more other information handling resources. An information handling resource may include any component system, device or apparatus of an information handling system, including without limitation a processor (e.g., processor 103), bus, memory (e.g., memory 104), input-output device and/or interface, storage resource (e.g., hard disk drives), network interface, electro-mechanical device (e.g., fan), display, power supply, and/or any portion thereof. An information handling resource may comprise any suitable package or form factor, including without limitation an integrated circuit package or a printed circuit board having mounted thereon one or more integrated circuits.

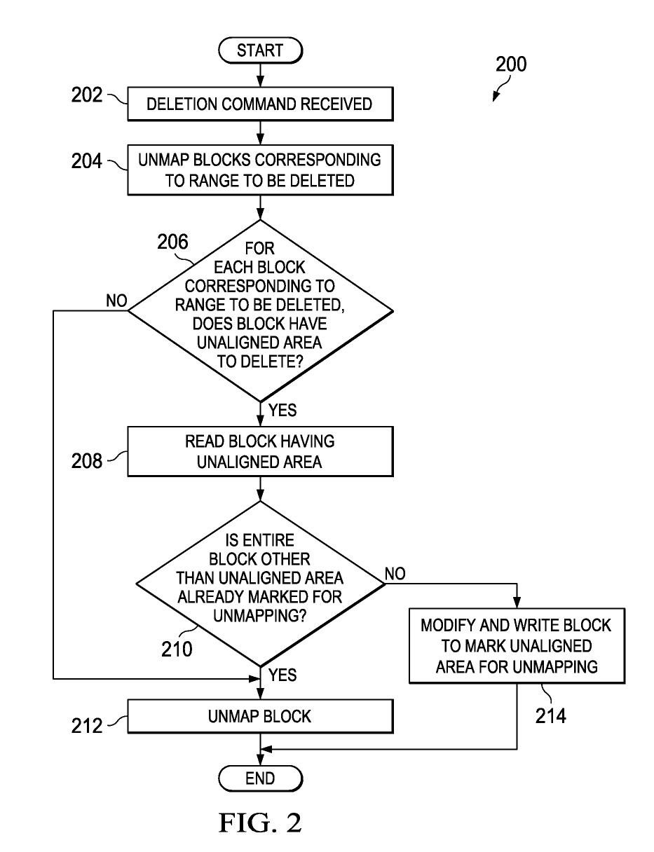

FIG. 2 illustrates a flow chart of an example method 200 for managing deletion of data on a storage resource 114, in accordance with the present disclosure. According to some embodiments, method 200 may begin at step 202. As noted above, teachings of the present disclosure may be implemented in a variety of configurations of information handling system 102. As such, the preferred initialization point for method 200 and the order of the steps comprising method 200 may depend on the implementation chosen.

At step 202, file system manager 106 may receive a deletion command for deleting all or part of a file stored on storage resource 114. At step 204, in response to the deletion command, file system manager 106 may unmap, from a logical-to-physical map for the storage resource, blocks including the range of data to be deleted.

At step 206, for each block including the range to be deleted, file system manager 106 may determine whether such block has an area to delete that is not aligned with the block boundaries. If the area to be deleted is unaligned with block boundaries, method 200 may proceed to step 208. Otherwise, method 200 may proceed to step 212.

At step 208, in response to a determination that the area to be deleted is unaligned with block boundaries, file system manager 106 may read the block. At step 210, file system manager 106 may determine whether the entire block, other than the unaligned area, has already been marked for unmapping. If the entire block, other than the unaligned area, has already been marked for unmapping, method 200 may proceed to step 212. Otherwise, method 200 may proceed to step 214.

At step 212, in response to a determination that the area to be deleted is aligned with block boundaries or a determination that the entire block, other than the unaligned area, has already been marked for unmapping, file system manager 106 may unmap the block from the logical-to-physical map for the storage resource, thus freeing the block for use by file system manager 106 to store new data. After completion of step 212, method 200 may end with respect to the block at issue, and steps 206-210 may repeat for any remaining affected blocks.

At step 214, in response to a determination that any portion of the block, other than the unaligned area, has not already been marked for unmapping, file system manager 106 may modify and rewrite the block such that the unaligned area is marked for unmapping. To mark an unaligned area for unmapping, file system manager 106 may write a particular bitstream to the unaligned area (e.g., all binary logic “1's” or all binary logic “0's”). After completion of step 212, method 200 may end with respect to the block at issue, and steps 206-210 may repeat for any remaining affected blocks.

Thus, in accordance with method 200, once it is evident that an entire block of data has been deleted, the block is unmapped.

Although FIG. 2 discloses a particular number of steps to be taken with respect to method 200, method 200 may be executed with greater or lesser steps than those depicted in FIG. 2. In addition, although FIG. 2 discloses a certain order of steps to be taken with respect to method 200, the steps comprising method 200 may be completed in any suitable order.

Method 200 may be implemented using information handling system 120 or any other system operable to implement method 200. In certain embodiments, method 200 may be implemented partially or fully in software and/or firmware embodied in computer-readable media.

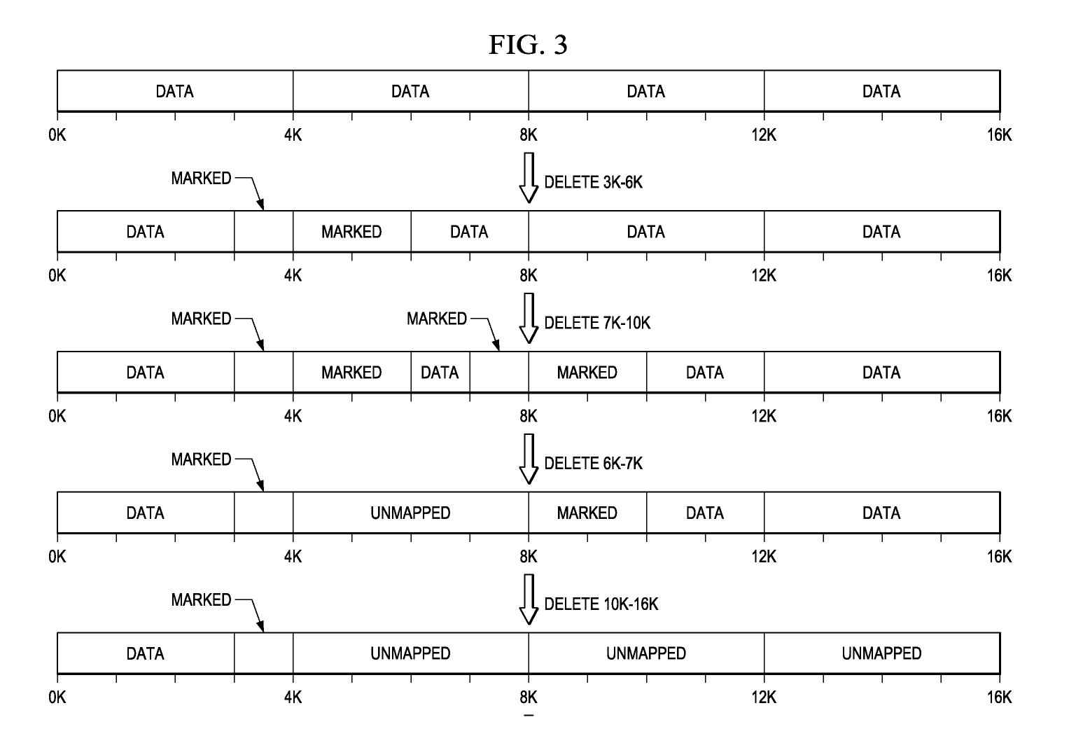

FIG. 3 illustrates a flow diagram relating to an area of storage on a storage resource to further illustrate the operation of method 200, in accordance with the present disclosure. FIG. 3 depicts an example 16-kilobyte range of data comprising four blocks of four kilobytes each, each storing file data. Consider that file system manager 106 receives a command for deletion of the data stored in the address range 3K to 6K. Such deletion would affect blocks with address range 0K to 4K and 4K to 8K, but does not require the deletion of the entire blocks. Instead, each of such blocks have areas to delete that are unaligned with their block boundaries (as determined at step 206). In each block, there are portions other than the unaligned areas that are not already marked for deletion (as determined in step 210). Accordingly, file system manager 106 would, for each block, modify and write the block to mark the unaligned areas for unmapping (step 214).

At a later time, consider that file system manager 106 receives a command for deletion of the data stored in the address range 7K to 10K. Such deletion would affect blocks with address range 4K to 8K and 8K to 12K, but does not require the deletion of the entire blocks. Instead, each of such blocks have areas to delete that are unaligned with their block boundaries (as determined at step 206). In each block, there are portions other than the unaligned areas that are not already marked for deletion (as determined in step 210). Accordingly, file system manager 106 would, for each block, modify and write the block to mark the unaligned areas for unmapping (step 214).

At another later time, consider that file system manager 106 receives a command for deletion of the data stored in the address range 6K to 7K. Such deletion would affect the block with address range 4K to 8K, but does not require the deletion of the entire block. Instead, the block has areas to delete that are unaligned with their block boundaries (as determined at step 206). The entire block, other than the unaligned area, is already marked for deletion (as determined in step 210). Accordingly, file system manager 106 would unmap the block from the logical-to-physical mapping of storage resource 112 (step 212).

At another later time, consider that file system manager 106 receives a command for deletion of the data stored in the address range 10K to 16K. Such deletion would affect blocks with address range 8K to 12K and 12K to 16K. For the block with address range 8K to 12K, such deletion would not require deletion of the entire block. Instead, the block has areas to delete that are unaligned with their block boundaries (as determined at step 206). The entire block, other than the unaligned area, is already marked for deletion (as determined in step 210). Accordingly, file system manager 106 would unmap the block from the logical-to-physical mapping of storage resource 112 (step 212). As for the block with address range 12K to 16K, the deletion does require deletion of the entire block. Accordingly, file system manager 106 would unmap the block from the logical-to-physical mapping of storage resource 112 (step 212).

Although the foregoing discussion contemplates determinations made at the block level, it is understood that such determination could be made at any suitable unit (e.g., block, page, etc.) of storage resource 114.

Although the present disclosure has been described in detail, it should be understood that various changes, substitutions, and alterations can be made hereto without departing from the spirit and the scope of the disclosure as defined by the appended claims.

What is claimed is:

1. A method comprising:
in response to receiving a command to delete data on a storage resource, determining, for a storage unit of the storage resource comprising a range of data to be deleted in response to the command, whether such storage unit has an area to delete responsive to the command that is not aligned with boundaries of the storage unit;
in response to determining that the storage unit has an area to delete responsive to the command that is not aligned with boundaries of the storage unit, determining whether the entire storage unit, other than the area to delete responsive to the command that is not aligned with boundaries of the storage unit, is marked for unmapping;
in response to determining that the entire storage unit, other than the area to delete responsive to the command that is not aligned with boundaries of the storage unit, is marked for unmapping, unmapping the storage unit from a logical-to-physical map for the storage resource; and
in response to determining that a portion of the storage unit, other than the area to delete responsive to the command that is not aligned with boundaries of the storage unit, is not marked for unmapping, modifying the storage unit to mark the area to delete responsive to the command that is not aligned with boundaries of the storage unit for unmapping.

2. The method of claim 1, comprising, in response to determining that the storage unit has an area to delete responsive to the command that is aligned with boundaries of the storage unit, unmapping the storage unit from the logical-to-physical map for the storage resource.

3. The method of claim 1, wherein the storage unit is a block.

4. The method of claim 1, wherein modifying the storage unit to mark the area to delete responsive to the command that is not aligned with boundaries of the storage unit for unmapping comprises writing a bitstream to the entire area.

5. The method of claim 4, wherein the bitstream substantially comprises all logical 1's.

6. The method of claim 4, wherein the bitstream substantially comprises all logical 0's.

7. An information handling system comprising:
a storage resource; and
a processor communicatively coupled to the storage resource and configured to:
in response to receiving a command to delete data on the storage resource, determine, for a storage unit of the storage resource comprising a range of data to be deleted in response to the command, whether such storage unit has an area to delete responsive to the command that is not aligned with boundaries of the storage unit;
in response to determining that the storage unit has an area to delete responsive to the command that is not aligned with boundaries of the storage unit, determine whether the entire storage unit, other than the area to delete responsive to the command that is not aligned with boundaries of the storage unit, is marked for unmapping;
in response to determining that the entire storage unit, other than the area to delete responsive to the command that is not aligned with boundaries of the storage unit, is marked for unmapping, unmap the storage unit from a logical-to-physical map for the storage resource; and
in response to determining that a portion of the storage unit, other than the area to delete responsive to the command that is not aligned with boundaries of the storage unit, is not marked for unmapping, modify the storage unit to mark the area to delete responsive to the command that is not aligned with boundaries of the storage unit for unmapping.

8. The information handling system of claim 7, the processor further configured to, in response to determining that the storage unit has an area to delete responsive to the command that is aligned with boundaries of the storage unit, unmap the storage unit from the logical-to-physical map for the storage resource.

9. The information handling system of claim 7, wherein the storage unit is a block.

10. The information handling system of claim 7, wherein modifying the storage unit to mark the area to delete responsive to the command that is not aligned with boundaries of the storage unit for unmapping comprises writing a bitstream to the entire area.

11. The information handling system of claim 10, wherein the bitstream substantially comprises all logical 1's.

12. The information handling system of claim 10, wherein the bitstream substantially comprises all logical 0's.

13. An article of manufacture comprising:
a computer readable medium; and
computer-executable instructions carried on the computer readable medium, the instructions readable by a processor, the instructions, when read and executed, for causing the processor to:
in response to receiving a command to delete data on the storage resource, determine, for a storage unit of the storage resource comprising a range of data to be deleted in response to the command, whether such storage unit has an area to delete responsive to the command that is not aligned with boundaries of the storage unit;
in response to determining that the storage unit has an area to delete responsive to the command that is not aligned with boundaries of the storage unit, determine whether the entire storage unit, other than the area to delete responsive to the command that is not aligned with boundaries of the storage unit, is marked for unmapping;
in response to determining that the entire storage unit, other than the area to delete responsive to the command that is not aligned with boundaries of the storage unit, is marked for unmapping, unmap the storage unit from a logical-to-physical map for the storage resource; and
in response to determining that a portion of the storage unit, other than the area to delete responsive to the command that is not aligned with boundaries of the storage unit, is not marked for unmapping, modify the storage unit to mark the area to delete responsive to the command that is not aligned with boundaries of the storage unit for unmapping.

14. The article of claim 13, the instructions for further causing the processor to, in response to determining that the storage unit has an area to delete responsive to the command that is aligned with boundaries of the storage unit, unmap the storage unit from the logical-to-physical map for the storage resource.

15. The article of claim 13, wherein the storage unit is a block.

16. The article of claim 13, wherein modifying the storage unit to mark the area to delete responsive to the command that is not aligned with boundaries of the storage unit for unmapping comprises writing a bitstream to the entire area.

17. The article of claim 16, wherein the bitstream substantially comprises all logical 1's.

18. The article of claim 16, wherein the bitstream substantially comprises all logical 0's.
